(19) United States
(12) Patent Application Publication
(10) Pub. No.: US 2009/0315711 A1
(43) Pub. Date: Dec. 24, 2009

(54) DIGITAL FRAME AND POWER SAVING METHOD THEREOF

(75) Inventor: Zhi-Hai ZHANG, Suzhou (TW)

Correspondence Address: QUINTERO LAW OFFICE, PC, 2210 MAIN STREET, SUITE 200, SANTA MONICA, CA, 90405, US

(73) Assignee: QISDA CORPORATION, Taoyuan County (TW)

(21) Appl. No.: 12/488,434

(22) Filed: Jun. 19, 2009

(30) Foreign Application Priority Data
Jun. 24, 2008 (TW) TW97123484

(51) Int. Cl. G08B 21/00

(52) U.S. Cl. 340/540

(57) ABSTRACT

A power saving method for a digital frame is provided, wherein the digital frame includes a sensor for object detection within a specific area near the digital frame. When no entity is detected by the sensor within the specific area for a predetermined time period, the digital frame automatically switches to a power down mode for saving power consumption.

### CROSS REFERENCE TO RELATED APPLICATIONS

This Application claims priority of Taiwan Patent Application No. 097123484, filed on Jun. 24, 2008, the entirety of which is incorporated by reference herein.

### TECHNICAL FIELD

The application relates in general to a digital frame and in particular to a power saving method for a digital frame.

### DESCRIPTION OF THE RELATED ART

Conventional digital frames are powered by a fixed AC power source through a cable and adapter connected thereto. The digital frame is restricted within a distance near the power source due to cable length limitations, thus not only impairing integral profile of the digital frame, but also reducing portability and convenience of usage. Furthermore, as the processing chips and the display of the digital frame usually consume considerable power, the digital frame is not suitable for long-term usage when powered by an internal battery.

### BRIEF SUMMARY

The present application provides a power saving method for a digital frame, wherein the digital frame includes a sensor for object detection within a specific area near the digital frame. When no entity is detected near the sensor within the specific area for a predetermined time period, the digital frame automatically switches to a power down mode for saving power consumption.

### BRIEF DESCRIPTION OF DRAWINGS

The application can be more fully understood by reading the subsequent detailed description and examples with references made to the accompanying drawings, wherein:

FIG. 1 is perspective diagram of a system architecture of a digital frame according to an embodiment of the invention;

FIG. 2 is a perspective diagram of another system architecture of a digital frame according to an embodiment of the invention; and

FIG. 3 is a flow chart of a power saving method for a digital frame according to an embodiment of the invention.

### DETAILED DESCRIPTION

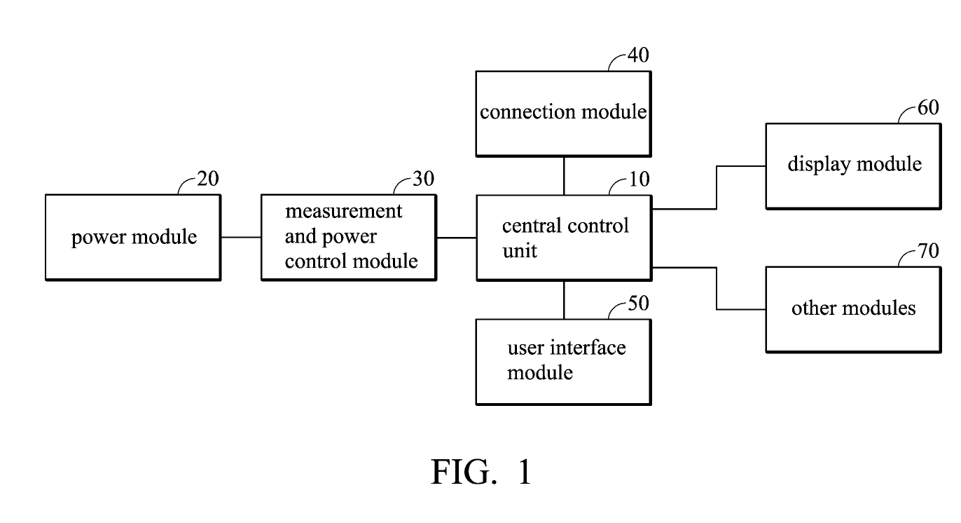

Referring to FIG. 1, an embodiment of a system architecture of a digital frame comprises a central control unit 10, a power module 20, a measurement and power control module 30, a connection module 40, a user interface module 50, a display module 60, and other modules 70. The connection module 40 may be a USB connector, the power module 20 may be a battery, and the user interface module 50 may be a control panel or keypad for operation of the digital frame. The display module 60 may be an LCD for displaying digital images.

As shown in FIG. 1, the connection module 40, the user interface module 50, the display module 60, and the other modules 70 directly connect to the central control unit 10. The measurement and power control module 30 connects the power module 20 with the central control unit 10. In this embodiment, the measurement and power control module 30 includes a sensor and a power control circuit. The sensor may be an infrared sensor for object or human detection within a specific distance therefrom. When the sensor detects any human present within the specific distance for a predetermined time period, the power control circuit transmits a control signal to the central control unit 10, such that the digital frame switches to a power down mode for saving power consumption.

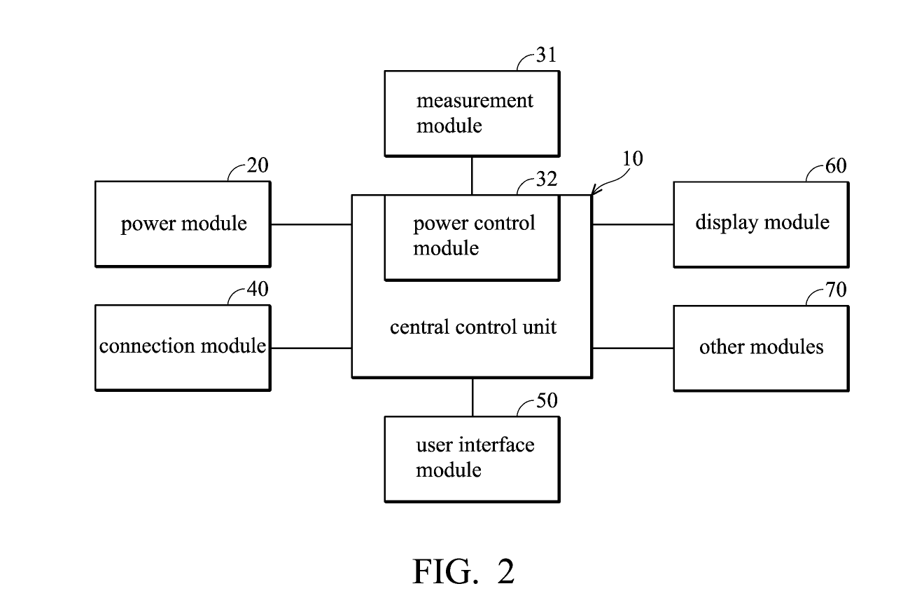

Referring to FIG. 2, another embodiment of a system architecture of a digital frame comprises a power control module 32 integrated into the central control unit 10. As shown in FIG. 2, the power control module 32 and a measurement module 31 electrically connect to each other and act as the measurement and power control module 30 of FIG. 1. The measurement module 31 may include a sensor for object or human detection within a specific distance therefrom. When the sensor detects any human within the specific distance for a predetermined time period, the measurement module 31 transmits a signal to the power control module 32, such that the digital frame switches to a power down mode for saving power consumption.

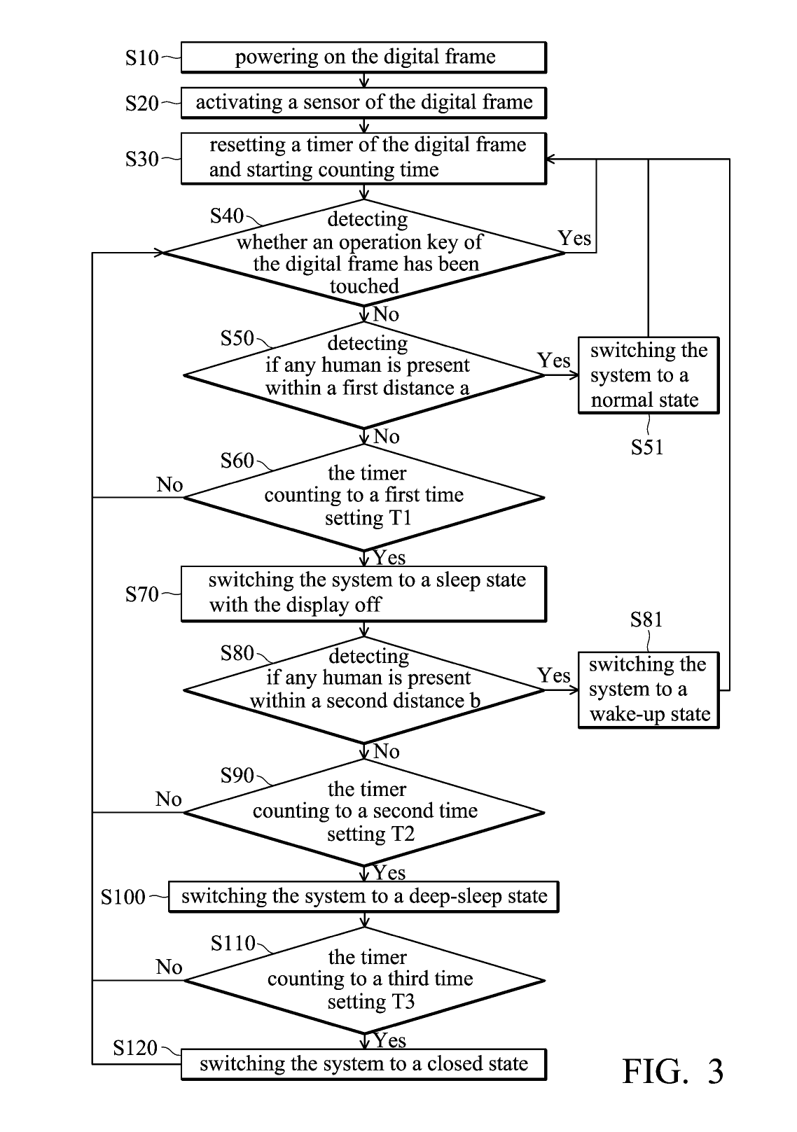

Referring to FIG. 3, the invention further provides a power saving method in accordance with the digital frames of FIGS. 1 and 2. First, the digital frame is powered on (step S10), and a sensor of the digital frame is activated (step S20) for human detection within a specific distance therefrom, wherein the sensor may be an infrared sensor. Subsequently, a timer of the digital frame is reset and starts counting time (step S30). After the initiation of steps S10˜S30, it is detected whether an operation key of the digital frame has been touched (step S40). If it is detected that the operation key of the digital frame has been touched, the timer is reset and restarts counting time (back to step S30). If it is detected that the operation key of the digital frame has not been touched, the sensor continues detecting if any human is present within a first distance a (step S50), until the timer counts to a first time setting T1 (step S60).

As shown in FIG. 3, before the timer counts to the first time setting T1, the system continues repeating steps S40˜S60. When the sensor detects any human present within the first distance a, the system switches to a normal state (step S51) with the display on and returns to step S30. On the contrary, if the sensor detects that no object or human is present within the first distance a and the timer counts to the first time setting T1, the system switches to a sleep state with the display off for saving power (step S70). After the timer counts to the first time setting T1, the sensor further detects if any human is present within a second distance b (step S80) until the timer counts to a second time setting T2 (step S90), wherein the second distance b exceeds the first distance a (b>a), and T2>T1.

During the period from the first time setting T1 to the second time setting T2, the system continues repeating the steps S40˜S90. When the sensor detects a human present within the first or second distance a or b during the period, the system respectively switches to a normal state (step S51) or wake-up state (step S81) and returns to step S30. On the contrary, if no entity is present within the first or second distance a or b, and the timer counts to a second time setting T2, the system switches to a deep-sleep state (step S100). Power consumption of the digital frame in the normal state or the wake-up state exceeds that of the digital frame in the sleep state or the deep-sleep state.

When the sensor detects any human present within the first or second distance a or b during the period from the second time setting T2 to a third time setting T3 (T3>T2), the system switches to normal state (step S51) or wake-up state (step S81), respectively. If no entity is present within the first or second distance a or b, and the timer counts to the third time setting T3 (step S110), the system switches to a closed state (step S120). When the system is in the closed state, the sensor can still detect if any human present within the first or second distance a or b (step S50 or S80), and correspondingly, the system can switch to the normal state (step S51) or wake-up state (step S81) for normal usage.

The invention provides a digital frame capable of human detection within a specific area. When no entity is present in the area for a predetermined time period, the system can automatically switch to different states, such as sleep state, deep-sleep state or closed state, under a power down mode according to the distance and time period. The order ranking of power consumption is as follows: normal state, wake-up state, sleep state, deep-sleep state, and closed state. With the sensor capable of human detection within a specific area, the system can switch to individual states according to a multi-step power saving strategy, thereby saving power consumption of the digital frame and extending time of usage.

While the invention has been described by way of example and in terms of embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A power saving method for a digital frame having a display, comprising:
providing a sensor to detect whether any human is present within a specific area; and
switching the digital frame to a power down mode when no human is detected by the sensor for a predetermined time period.

2. The method as claimed in claim 1, wherein the method further comprises:
providing a timer, wherein when no human is detected by the sensor within a first distance therefrom and the timer counts to a first time setting, the digital frame switches to a sleep state with the display off.

3. The method as claimed in claim 2, wherein the method further comprises:
switching the digital frame to a normal state with the display on for normal usage when the sensor detects that a human is present within the first distance before the timer counts to the first time setting.

4. The method as claimed in claim 3, wherein the method further comprises:
resetting the timer and restarting counting time when the digital frame switches to the normal state.

5. The method as claimed in claim 3, wherein power consumption of the digital frame in the normal state exceeds that of the digital frame in the sleep state.

6. The method as claimed in claim 3, wherein the method further comprises:
switching the digital frame to a deep-sleep state when no human is detected by the sensor within the first distance or a second distance and the timer counts to a second time setting, wherein the second distance exceeds the first distance, and the second time setting exceeds the first time setting.

7. The method as claimed in claim 6, wherein the method further comprises:
switching the digital frame to a wake-up state when the sensor detects that a human is present within the second distance and the timer counts to the second time setting.

8. The digital frame as claimed in claim 7, wherein the method further comprises:
resetting the timer and restarting counting time when the digital frame switches to the wake-up state.

9. The digital frame as claimed in claim 7, wherein power consumption of the digital frame in the wake-up state exceeds that of the digital frame in the sleep state.

10. The digital frame as claimed in claim 7, wherein the method further comprises:
switching the digital frame to a closed state when no human is detected by the sensor within the second distance and the timer counts to a third time setting, wherein the third time setting exceeds the second time setting.

11. A digital frame, comprising:
a central control unit;
a power module; and
a measurement and power control module connecting to the power module with the central control unit, wherein the measurement and power control module comprises a sensor and a power control circuit, and when no human is detected by the sensor within a specific area for a predetermined time period, the power control module transmits a control signal to the central control unit to switch the digital frame to a power down mode.

12. The digital frame as claimed in claim 11, wherein the sensor comprises an infrared sensor.

13. The digital frame as claimed in claim 11, wherein the power module comprises a battery.

14. A digital frame, comprising:
a central control unit, comprising a power control module;
a power module, connecting to the central control unit; and
a measurement module connecting to the central control unit, wherein the measurement module comprises a sensor, and when no human is detected by the sensor within a specific area for a predetermined time period, the measurement module transmits a signal to the central control unit to switch the digital frame to a power down mode.

15. The digital frame as claimed in claim 14, wherein the sensor comprises an infrared sensor.

16. The digital frame as claimed in claim 14, wherein the power module comprises a battery.
